(19) United States
(12) Patent Application Publication
(10) Pub. No.: US 2016/0140489 A1
(43) Pub. Date: May 19, 2016

(54) MANAGING WAREHOUSE INFORMATION

(71) Applicant: Alibaba Group Holding Limited, George Town (KY)

(72) Inventors: Yueyang Chen, Hangzhou (CN); Debing Ding, Hangzhou (CN)

(21) Appl. No.: 14/935,179

(22) Filed: Nov. 6, 2015

(30) Foreign Application Priority Data
Nov. 13, 2014 (CN) 201410641285.7

(51) Int. Cl. G06Q 10/08

(52) U.S. Cl. CPC G06Q 10/087

(57) ABSTRACT

Managing warehouse information is disclosed, including: receiving warehouse storage device information from a warehouse storage device; establishing a warehouse identifier corresponding to the warehouse storage device; storing warehouse information corresponding to the warehouse identifier based at least in part on the warehouse storage device information; receiving request information from a client; determining whether the request information satisfies a first preset rule or a second preset rule; generating lock-in information corresponding to whichever of the first preset rule and the second preset rule is satisfied by the request information; updating the warehouse information based at least in part on the lock-in information; transmitting the lock-in information to the client and to the warehouse storage device; receiving a confirmation message from the client confirming use of requested resources; generating resource transfer information based at least in part on the confirmation message; and transmitting the resource transfer information to the warehouse storage device.

### CROSS REFERENCE TO OTHER APPLICATIONS

This application claims priority to People's Republic of China Patent Application No. 201410641285.7 entitled A RESOURCE PROCESSING METHOD, SYSTEM AND SERVER, AND A WAREHOUSE MANAGEMENT METHOD AND DEVICE, filed Nov. 13, 2014 which is incorporated herein by reference for all purposes.

### FIELD OF THE INVENTION

The present application involves the field of warehouse management.

### BACKGROUND OF THE INVENTION

With the development of technology, the transmission of information via the Internet is increasingly being used to solve resource processing problems. For example, the transmission of information via the Internet can be used to achieve retrieval and use of resources by users.

One situation in which the Internet is used to handle resource processing is as follows: a server manages information for a single virtual warehouse that represents the inventory of resources (e.g., goods) available to be sold at various physical storage locations or addresses. The server can be used to record the quantity of resources available for retrieval and the scope of coverage of resources available for retrieval at each of the storage addresses. The resources can be products that are provided by various resource providers such as merchants, for example. A client that is interested in acquiring the sources stored at a storage location can transmit a request to the server to use a certain quantity of resources that may be available at a storage location associated with a particular address. If the request can be satisfied by the quantity of resources available at the storage location, the time period(s) over which the resources are available at the storage location, and the scope of geographical coverage associated with the storage location, then the server transmits information notifying the provider of the requested resources that the resources can be provided to the client during the time period specified in the request.

However, one downside to the above described technique of managing warehouse information is that the quantity of resources that can be retrieved by a client from a storage location typically can only be set within a specified time period and within a specified scope of coverage. For example, the quantity of resources that is available during the one specified time period likely refers to only the quantity of resources that is currently in stock.

### BRIEF DESCRIPTION OF THE DRAWINGS

Various embodiments of the invention are disclosed in the following detailed description and the accompanying drawings.

FIG. 1 is a diagram that shows an embodiment of a system for managing warehouse information.

FIG. 2 is a flow diagram that shows an embodiment of a process for managing warehouse information.

FIG. 3 is a diagram showing an embodiment of a process for managing warehouse information.

FIG. 4 is a diagram showing an embodiment of a system for managing warehouse information.

FIG. 5 is a diagram of a first example of a warehouse management server.

FIG. 6 is a diagram of a second example of a warehouse management server.

FIG. 7 is a diagram of an embodiment of a warehouse management device.

FIG. 8 is a functional diagram illustrating an embodiment of a programmed computer system for managing warehouse information.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments for managing warehouse information are described herein. In various embodiments, a warehouse management server receives warehouse storage device information from one or more warehouse storage devices. In some embodiments, a warehouse storage device corresponds to at least one warehouse and is configured to maintain updated information corresponding to at least one warehouse. As such, the warehouse storage device information maintained by the warehouse storage device and received at the warehouse management server includes at least one transfer cycle and a quantity of resources transferrable corresponding to each transfer cycle. In various embodiments, a “transfer cycle” indicates the time period (e.g., between two dates) during which a certain quantity of resources can be transferred out of a warehouse. In various embodiments, the warehouse management server stores a warehouse identifier and warehouse information corresponding to each set of warehouse storage device information. In various embodiments, the warehouse management server receives request information from one or more clients and compares the request information against one or more sets of warehouse information that the server has stored to determine whether a first preset rule or a second preset rule has been satisfied. In various embodiments, the warehouse management server generates lock-in information based on whichever one of the first preset rule or second preset rule that has been satisfied and sends the lock-in information to the client and the warehouse storage device. In various embodiments, “lock-in information” represents information that confirms that either one of the first preset rule and second preset rule has been satisfied by the request information.

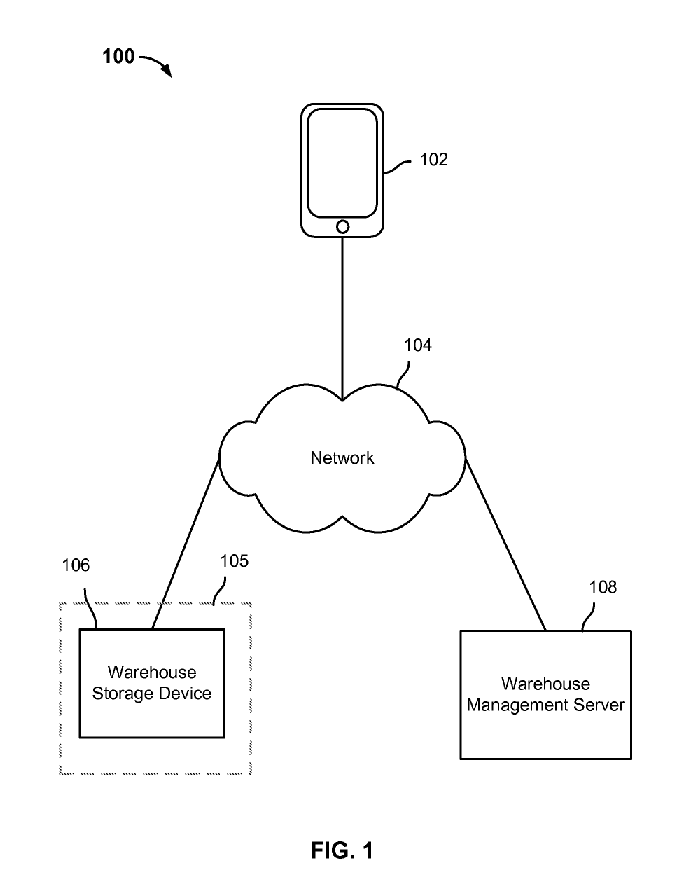

FIG. 1 is a diagram that shows an embodiment of a system for managing warehouse information. In the example, system 100 includes client 102, network 104, warehouse storage device 106, and warehouse management server 108. Network 104 includes high-speed data networks and/or communication networks.

Warehouse management server 108 is configured to receive warehouse storage device information from warehouse storage device 106 over network 104. Warehouse storage device 106 may be located inside or proximate to physical warehouse 105. For example, warehouse storage device 106 may be implemented using a hard disk. Warehouse storage device information comprises information maintained for at least one warehouse. In some embodiments, the warehouse storage device information maintained by a warehouse storage device corresponds to one warehouse. Warehouse management server 108 is configured to establish a warehouse identifier and warehouse information corresponding to the warehouse storage device information that it receives from warehouse storage device 106. The warehouse information includes at least one transfer cycle and a corresponding quantity of resources transferrable for each transfer cycle.

Warehouse management server 108 is configured to receive request information from client 102 over network 104. In various embodiments, the request information comprises information regarding a request by a resource user for a certain quantity of resources from a target warehouse during a specified transfer cycle. Warehouse management server 108 is configured to compare the request information to the stored warehouse information of the target warehouse to determine whether the resource destination address in the request information is within the geographical scope of coverage of the target warehouse and whether the requested quantity of resources can be serviced by the target warehouse during the specified transfer cycle. In the event that the resource destination address in the request information is within the geographical scope of coverage of the target warehouse and the requested quantity of resources can be serviced by the target warehouse during the specified transfer cycle, then a first preset rule is satisfied and warehouse management server 108 generates lock-in information corresponding to the first preset rule. Otherwise, in the event that the resource destination address in the request information is within the geographical scope of coverage of the target warehouse but the requested quantity of resources can only be serviced by the target warehouse using the combined quantities of resources that are transferrable across multiple transfer cycles, then a second preset rule is satisfied and warehouse management server 108 generates lock-in information corresponding to the second preset rule. In various embodiments, the lock-in information confirms that the request information has successfully requested resources from a target warehouse corresponding to whichever one of the first preset rule or the second preset rule that has been satisfied. Warehouse management server 108 is further configured to send the lock-in information to client 102 and warehouse storage device 106.

In some embodiments, warehouse management server 108 receives a confirmation message from client 102 that confirms that the resource user associated with client 102 has used the requested resources. The confirmation message includes at least a lock-in information identifier and a confirmation time. Based on the confirmation message, warehouse management server 108 generates resource transfer information and sends the resource transfer information to warehouse storage device 106 so that warehouse storage device 106 may cause the transfer of the requested resources to a resource user associated with client 102.

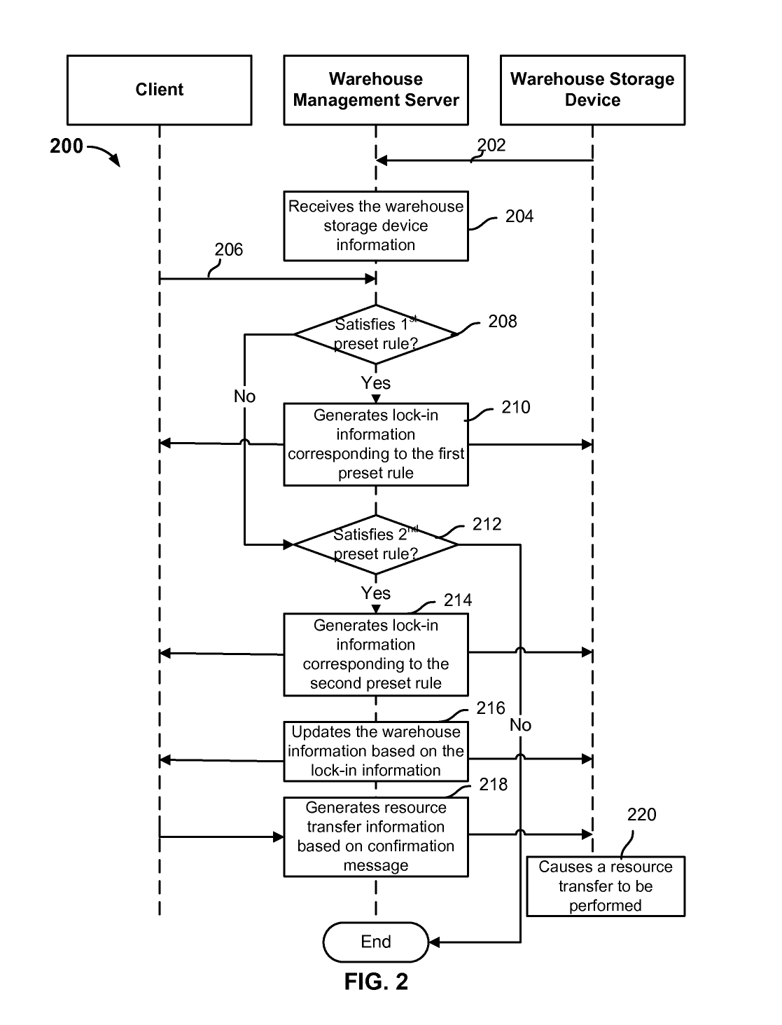

FIG. 2 is a flow diagram that shows an embodiment of a process for managing warehouse information. In some embodiments, process 200 is implemented at a system such as system 100 of FIG. 1.

At 202, a warehouse storage device transmits warehouse storage device information to a warehouse management server.

In various embodiments, a warehouse storage device stores information related to one or more warehouses. One or more warehouse storage devices can transmit the warehouse storage device information that each stores to a warehouse management server. In various embodiments, the warehouse management server manages information related to the inventory of resources, the ordering (e.g., purchasing) of the resources, and the transfer of resources associated with various warehouses. In various embodiments, the information stored by a warehouse storage device is referred to as “warehouse storage device information.” In various embodiments, the warehouse storage device information stored by a storage device corresponds to information pertaining to one or more warehouses at one or more respective physical locations. In various embodiments, the warehouse storage device information corresponding to a warehouse is configured by an administrator (e.g., owner) of the warehouse.

In some embodiments, the warehouse storage device information stored by and transmitted from a warehouse storage device may comprise: the warehouse storage device identifier, the warehouse storage device address information, the scope of coverage information corresponding to the warehouse storage device, a minimum of one transfer cycle associated with the warehouse storage device, and the total quantity of resources transferrable corresponding to each of the transfer cycles. In various embodiments, a different total quantity of resources transferrable can be configured for each corresponding transfer cycle.

In various embodiments, “resources” comprise one or more types of products. In various embodiments, the “storage device address” indicates the physical address of the storage device and/or the warehouse(s) with which it is associated. In some embodiments, a storage device may be located physically proximate to or inside an associated warehouse. In various embodiments, the “scope of coverage” corresponding to the storage device indicates the geographical area in which the resources stored at the warehouse(s) can be transferred (e.g., delivered to). For example, the scope of coverage may include a set of addresses, a geographical region (e.g., one or more cities, one or more counties, one or more zip codes, etc.), and an area on a map. In various embodiments, a “transfer cycle” indicates the time period (e.g., between two dates) during which a certain quantity of resources can be transferred out of a warehouse. For example, a transfer cycle refers to a time period in which a corresponding quantity of resources is available to be transferred (e.g., distributed) from a warehouse to a resource user (e.g., a consumer). For example, a transfer cycle can be represented as: 20140101-20140201, denoting the cycle between Jan. 1, 2014 and Feb. 1, 2014. In some embodiments, a transfer cycle includes the present time such that the corresponding quantity of resources comprises an amount of resources that is currently in stock (i.e., currently available) to be transferred from the warehouse. In some embodiments, a transfer cycle includes a future time period such that the corresponding quantity of resources comprises an amount of resources that is not currently in stock (i.e., available) but will become available to be transferred from the warehouse during that future time period. This latter transfer cycle with future available resources can be used for performing the sale of future resources (e.g., resources that are not yet currently available at the warehouse but will become available at a later time.) In some embodiments, transfer cycles associated with a set of warehouse storage device information may be adjacent in time and/or partially overlapping. In some embodiments, a set of warehouse storage device information comprises at least one of a transfer cycle that corresponds to a quantity of currently in stock resources and a transfer cycle that corresponds to a quantity of resources that will become available for transfer in the future.

At 204, the warehouse management server receives the warehouse storage device information transmitted from the warehouse storage device, establishes a warehouse identifier corresponding to the warehouse storage device, and stores warehouse information corresponding to the warehouse identifier based at least in part on the warehouse storage device information.

The warehouse management server receives the warehouse storage device information transmitted from each of the warehouse storage devices. In various embodiments, the warehouse management server establishes a warehouse identifier corresponding to the set of warehouse storage device information that was received from each warehouse storage device. In various embodiments, establishing a warehouse identifier comprises establishing a record and an identifier corresponding to a warehouse storage device. In various embodiments, there is a one-to-one correspondence between the warehouse and the warehouse storage device. Put another way, one warehouse storage device can be maintained for each warehouse. The warehouse identifier can therefore be used to uniquely identify the warehouse and corresponding warehouse storage device. In various embodiments, the warehouse information corresponding to a warehouse identifier comprises the warehouse storage device information received from the warehouse storage device that is associated with that warehouse identifier. As such, in various embodiments, the warehouse information may comprise: a warehouse identifier, the scope of coverage from the warehouse storage device information, the one or more transfer cycles from the warehouse storage device information, and the total quantity of resources transferrable corresponding to each transfer cycle from the warehouse storage device information.

As described above, each set of warehouse storage device information associated with a storage device can include one or more transfer cycles and a corresponding quantity of resources transferrable per each transfer cycle.

At 206, the warehouse management server receives request information transmitted from a client.

The warehouse management server can receive request information transmitted from the client. The client may comprise a client device that is used by a resource user to transmit request information to the warehouse management server via a network. For example, a resource user may comprise a consumer (e.g., a buyer). For example, the client may transmit request information to the warehouse management server via a website or an application associated with the warehouse management server.

In various embodiments, the request information may comprise: a request information identifier, the resource transfer destination, the target warehouse identifier, a specified transfer cycle associated with the target warehouse identifier, the name of the resources that need to be transferred during the specified transfer cycle, and the quantity of resources that is requested to be transferred. For example, a resource user may wish to indicate a specified transfer cycle during which to receive the requested resource because the resource user may either wish to receive the resources soon and therefore could indicate a transfer cycle that includes a time close to or including the present time, or the resource user may wish to receive the resources at a future time and could therefore indicate a transfer cycle that comprises a future time period. The specified transfer cycle also lets the resource provider know during which time period the requested resources need to be transferred to the resource user so that the resource provider does not transfer the requested resources too early or too late.

In various embodiments, the “target warehouse identifier” can be the warehouse identifier corresponding to the warehouse from which resources are requested to be transferred. In various embodiments, the “specified transfer cycle” can be used to indicate a desired transfer cycle of the transfer cycles associated with the target warehouse during which resources are requested to be transferred.

At 208, the warehouse management server determines whether the request information satisfies a first preset rule. In the event that the request information satisfies the first preset rule, control is transferred to 210. Otherwise, in the event that the request information does not satisfy the first preset rule, control is transferred to 212.

The warehouse management server determines whether or not the request information satisfies a first preset rule by comparing at least a portion of the request information to one or more sets of warehouse information that the server has stored. In various embodiments, the first preset rule indicates that 1) the resource transfer destination of the request information matches the scope of coverage of the warehouse associated with the target warehouse identifier of the request information and 2) the quantity of the requested resources in the request information is less than or equal to the total quantity of the requested resources that is transferrable corresponding to the specified transfer cycle in the warehouse associated with the target warehouse identifier of the request information.

The warehouse management server can compare the resource transfer destination that is included in the request information with the scope of coverage of the target warehouse that is identified in the request information to determine whether there is a match. Specifically, if the resource transfer destination that is included in the request information falls within the scope of coverage of the target warehouse that is identified in the request information, then this matching result obtained is successful. However, if the resource transfer destination that is included in the request information does not fall within the scope of coverage of the target warehouse that is identified in the request information, then this matching result is unsuccessful. For example, the resource transfer destination may indicate a street address and the scope of coverage of the target warehouse may be a zip code that has certain streets associated with the zip code. As such, if the street address of the resource transfer destination is included in the zip code that forms the scope of coverage of the target warehouse, then this comparison yields a successful matching result.

The warehouse management server can compare the quantity of the requested resources in the request information with the total quantity of the requested resources that are transferrable corresponding to the specified transfer cycle in the warehouse associated with the target warehouse identifier to determine whether the requested quantity is less than or equal to the total quantity. Specifically, if the quantity of the requested resources is less than or equal to the total quantity, then this matching result obtained is successful. However, if the quantity of the requested resources is greater than the total quantity, then this matching result is unsuccessful.

So long as both matching results as described above are successful, then the first preset rule is satisfied by the request information.

Determining whether or not the request information satisfies the first preset rule ensures that the resource transfer destination of the resource user is within the scope of coverage corresponding to the target warehouse that is identified in the request information, while also ensuring that the quantity of resources requested by the resource user is a resource quantity that can be provided by the warehouse associated with the storage device during the requested transfer cycle.

At 210, the warehouse management server generates lock-in information corresponding to the first preset rule and transmits the lock-in information to the client and the warehouse storage device.

If the request information received by the warehouse management server satisfies the first preset rule, then the warehouse management server generates lock-in information corresponding to the first preset rule indicating that the request can be fulfilled based on the first preset rule. In various embodiments, the lock-in information represents a confirmation that the request information satisfies either one of the first preset rule or the second preset rule and also represents that the resources requested by the request information are reserved to be transferred to the resource user.

In various embodiments, the lock-in information corresponding to the first preset rule may comprise: a lock-in information identifier, resource user information, the resource transfer destination that was included in the request information, the target warehouse identifier that was included in the request information, the specified transfer cycle associated with the target warehouse identifier that was included in the request information, the name of the resources that need to be transferred within the specified transfer cycle that is included in the request information, and the quantity of resources that is requested to be transferred that is included in the request information.

In various embodiments, the “lock-in information identifier” is generated by the warehouse management server based on the request information identifier that is included in the request information. For example, the lock-in information identifier can be the same as the request information identifier. In some embodiments, the resource user information is also generated based on the request information identifier that is included in the request information. For example, the resource user information may include the request information identifier.

At 212, the warehouse management server determines whether the request information satisfies a second preset rule. In the event that the request information satisfies the second preset rule, control is transferred to 214. Otherwise, in the event that the request information does not satisfy the second preset rule, process 200 ends.

If the request information does not satisfy the first preset rule, then the warehouse management server can determine whether the request information instead satisfies a second preset rule by comparing at least a portion of the request information to one or more sets of warehouse information that the server has stored.

In various embodiments, the second preset rule indicates that 1) the resource transfer destination of request information matches the scope of coverage of the warehouse associated with the target warehouse identifier of the request information and 2) the quantity of the requested resources in the request information is less than or equal to the sum of the total quantities of the requested resources that is transferrable over multiple (i.e., more than one) transfer cycles in the warehouse associated with the target warehouse identifier of the request information. In some embodiments, the specified transfer cycle that is included in the request information is included in the multiple transfer cycles in the warehouse associated with the target warehouse identifier.

The warehouse management server can compare the resource transfer destination that is included in the request information with the scope of coverage of the target warehouse that is identified in the request information to determine whether there is a match. Specifically, if the resource transfer destination that is included in the request information falls within the scope of coverage of the target warehouse that is identified in the request information, then this matching result obtained is successful. However, if the resource transfer destination that is included in the request information does not fall within the scope of coverage of the target warehouse that is identified in the request information, then this matching result is unsuccessful.

If the request information does not satisfy the first preset rule because the quantity of the requested resources in the request information is greater than the total quantity of the requested resources that are transferrable over the specified transfer cycle, then the request information may still satisfy the second preset rule, which indicates that the quantity of the requested resources in the request information can be less than or equal to the sum of the total quantities of the requested resources over more than one transfer cycle in the target warehouse associated with the target warehouse identifier. For example, the name of the requested resource is tote bags, the requested quantity is 100 tote bags, and the specified transfer cycle is Jan. 1, 2015 to Feb. 1, 2015. If the target warehouse associated with the target warehouse identifier is associated with a total of 40 transferrable tote bags during the specified transfer cycle of Jan. 1, 2015 to Feb. 1, 2015, then the request information does not meet the first preset rule for at least the reason that the requested quantity of 100 tote bags cannot be satisfied in the specified transfer cycle. However, another transfer cycle of Feb. 2, 2015 to Mar. 2, 2015 is associated with 70 transferrable tote bags and so the request information does meet the second preset rule for at least the reason that the requested quantity of 100 tote bags can be satisfied based on the sum of the total quantities of transferrable tote bags across the transfer cycles of Jan. 1, 2015 to Feb. 1, 2015 and Feb. 2, 2015 to Mar. 2, 2015.

In some embodiments, the multiple transfer cycles that can be used to satisfy the requested quantity of resources may be adjacent in time. In some embodiments, the multiple transfer cycles that can be used to satisfy the requested quantity of resources may be selected by the resource provider associated with the requested resource.

As such, the second preset rule allows for the coordination of the quantities of resources transferrable within the multiple transfer cycles within a single warehouse to realize flexible processing of resources.

At 214, the warehouse management server generates lock-in information corresponding to the second preset rule and transmits the lock-in information to the client and the warehouse storage device.

If the request information received by the warehouse management server satisfies the second preset rule, then the warehouse management server generates lock-in information corresponding to the second preset rule indicating that the request can be fulfilled based on the second preset rule.

The lock-in information corresponding to the second preset rule may comprise: a lock-in information identifier, resource user information, the resource transfer destination that was included in the request information, the target warehouse identifier that was included in the request information, the multiple transfer cycles associated with the target warehouse identifier whose sum of total quantities of transferrable resources is greater than the quantity of resources that is requested to be transferred that is included in the request information, the name of the resources that need to be transferred within the multiple transfer cycles that is included in the request information, and the quantity of resources that is requested to be transferred that is included in the request information.

In various embodiments, the “lock-in information identifier” is generated by the warehouse management server based on the request information identifier that is included in the request information. For example, the lock-in information identifier can be the same as the request information identifier. In some embodiments, the resource user information is also generated based on the request information identifier that is included in the request information.

At 216, the warehouse management server updates the warehouse information based at least in part on the lock-in information, and transmits the lock-in information to the client and the warehouse storage device.

The warehouse management server updates its stored warehouse information based on the lock-in information. In various embodiments, in the event that the request information satisfied the first preset rule, updating the warehouse information of the warehouse includes updating the quantity of resources transferrable during the specified transfer cycle included in the warehouse information to be a new quantity that is the quantity of the requested resources before the update less the requested quantity that is included in the request information. For example, if the quantity of the requested resources associated with the specified transfer cycle before the update is 120 and the requested quantity is 50, then the new quantity is (120−50=70). In various embodiments, in the event that the request information satisfied the second preset rule and not the first preset rule, updating the warehouse information of the warehouse includes updating the quantity of resources transferrable during each of the multiple transfer cycles whose sum of total quantities of transferrable resources is greater than or equal to the quantity of resources that is requested to be transferred to be a new quantity that is the quantity of the requested resources before the update less a portion of the requested quantity that is included in the request information. For example, if the quantity of the requested resources of each of two transfer cycles before the update is 100 and 50, respectively, and the requested quantity is 120, then the new quantities for the two transfer cycles may be 0 and 30.

In various embodiments, the lock-in information can be used as verification information at the time that the resources that are associated with the request information are used. In various embodiments, to “use” the requested resources includes to pay for the requested resources. For example, when or after the requested resources are used by the resource user, the warehouse management server receives information confirming the use of the resources that are associated with the lock-in information.

In various embodiments, the lock-in information is used by the warehouse storage device to update the quantity of the resources that are stored at the warehouse. For example, based on the lock-in information that the warehouse storage device receives, the storage device can update its own stored quantities of resources transferrable during the transfer cycles associated with the lock-in information.

At 218, the warehouse management server receives a confirmation message from the client confirming the use of requested resources, generates resource transfer information based at least in part on the confirmation message, and transmits the resource transfer information to the warehouse storage device.

The warehouse management server can receive a confirmation message transmitted from the client confirming the use of the resources. In various embodiments, the confirmation message comprises the lock-in information identifier and the confirmation time. In some embodiments, the “confirmation time” comprises the time at which the resource user submitted payment for the transfer of the requested resources.

Based on the confirmation message, the warehouse management server can generate resource transfer information. In some embodiments, in the event that the request information satisfies the first preset rule, the resource transfer information comprises one or more of the following: a resource transfer information identifier, the name of the requested resource, the specified transfer cycle, the quantity of the requested resource, the address of the resource user, the resource user information, and the confirmation time. In some embodiments, in the event that the request information satisfies the second preset rule, the resource transfer information comprises one or more of the following: a resource transfer information identifier, the name of the requested resource, the multiple transfer cycles whose sum of total quantities of transferrable resources is greater than the quantity of resources that is requested to be transferred, the quantity of the requested resource, the address of the resource user, the resource user information, and the confirmation time.

In various embodiments, the “resource transfer information identifier” is generated by the warehouse management server based on the information identifier to ensure the accuracy of the resource transfer information. For example, the lock-in information identifier can be the same as the request information identifier.

The warehouse management server transmits the resource transfer information to the warehouse storage device in order to facilitate the warehouse storage device in causing the resource transfer operation to be performed.

At 220, the warehouse storage device causes a resource transfer to be performed based at least in part on the received resource transfer information.

The warehouse storage device is configured to cause the resource transfer to be performed based on the resource transfer information. For example, performing a resource transfer comprises causing the requested resources of the resource transfer information to be delivered to the address of the resource user from the target warehouse. The warehouse storage device can receive multiple pieces of resource transfer information from one or more warehouse management servers and cause resource transfers to be performed in a sequence. In some embodiments, the warehouse storage device can sort the resource transfer information based on the cut-off times of the specified transfer cycles and perform the resource transfer for the specified transfer cycle having the nearest cut-off time first. In some embodiments, the “cut-off time” of a transfer cycle is a predetermined ending time of that transfer cycle. In some embodiments, the warehouse storage device can sort the resource transfer information by confirmation times from earliest to latest and perform the resource transfer for the request having the earliest confirmation time first. Using the resource transfer scheme described above, it is possible to ensure that the resources can be transferred to the resource transfer destination in a timely manner in order to satisfy the requirements of the resource user. Other resource transfer schemes other than the examples described above can be used in practice.

In some embodiments, in the event that the first preset rule is satisfied, then the resource transfer is performed during the specified transfer cycle of the request information. In some embodiments, in the event that the second preset rule is satisfied, then the resource transfer is performed during the latest transfer cycle of the multiple transfer cycles that is to provide the requested quantity of resources. In some embodiments, in the event that the second preset rule is satisfied, then a resource transfer is performed during each of the multiple transfer cycles that are to provide the requested quantity of resources for transferring a corresponding portion of the requested quantity of resources.

In some embodiments, the warehouse management server can also receive correction information transmitted from the warehouse storage device and the warehouse management server can update its own stored version of the warehouse information corresponding to that warehouse storage device based on the correction information. In some embodiments, the correction information can be used to correct one or more of the following pieces of information that is included in the warehouse storage device information: the warehouse storage device address information, the scope of coverage information corresponding to the warehouse storage device, a minimum of one transfer cycle associated with the warehouse storage device, and the total quantity of resources transferrable corresponding to each transfer cycle. After it has received and stored the warehouse information, the warehouse management server can receive correction information transmitted from the warehouse storage device at any time in order to ensure the consistency of the warehouse information stored at the warehouse management server and that which is stored at the warehouse storage device. The warehouse management server can immediately update its own stored version of the warehouse information corresponding to that warehouse storage device based on the correction information to correctly facilitate a resource user's request of resources.

As described above, process 200 enables for a warehouse storage device to be configured to correspond to a warehouse. One or more transfer cycles can be set up for each warehouse and a corresponding quantity of resources transferrable can be configured for each transfer cycle. Configuring multiple transfer cycles and corresponding quantities of resources transferrable for one warehouse storage device allows for the warehouse to flexibly service the requests for resources.

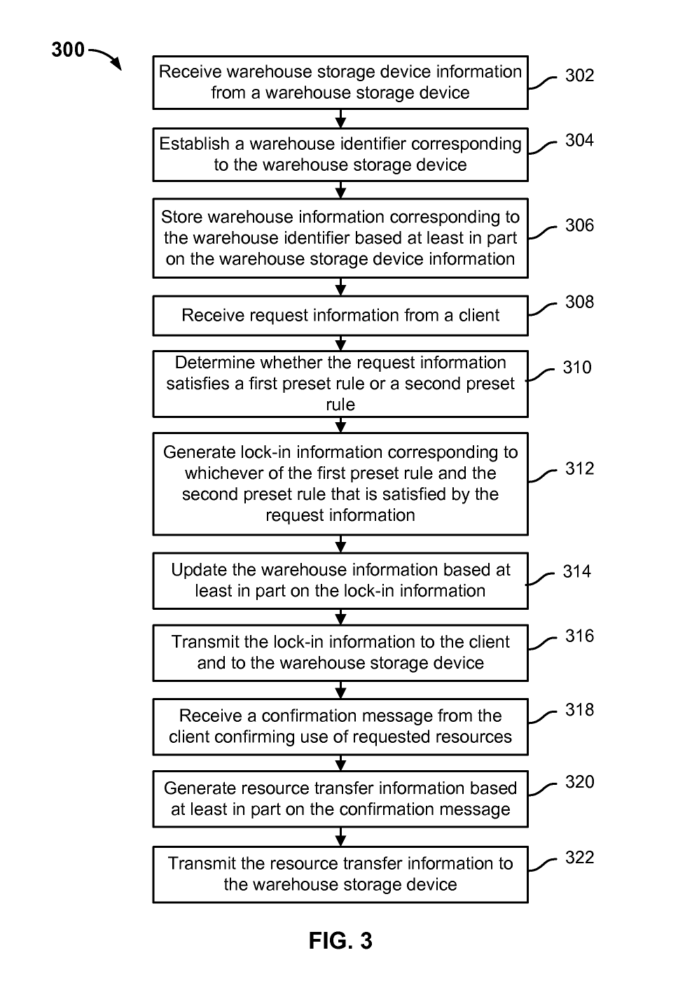

FIG. 3 is a diagram showing an embodiment of a process for managing warehouse information. In some embodiments, process 300 is implemented at system 100 of FIG. 1. Specifically, in some embodiments, process 300 is implemented at warehouse management server 108.

At 302, warehouse storage device information transmitted from a warehouse storage device is received. In some embodiments, there is a one-to-one correspondence between a warehouse and a corresponding warehouse storage device. Put another way, one warehouse storage device can be maintained for each warehouse.

In some embodiments, the warehouse storage device information stored by and transmitted from a warehouse storage device may comprise: the warehouse storage device identifier, the warehouse storage device address information, the scope of coverage information corresponding to the warehouse storage device, a minimum per one transfer cycle associated with the warehouse storage device, and the total quantity of resources transferrable corresponding to each of the transfer cycles. In various embodiments, a different total quantity of resources transferrable can be configured for each corresponding transfer cycle.

At 304, a warehouse identifier corresponding to the warehouse storage device is established. In various embodiments, the warehouse management server establishes a warehouse identifier corresponding to the set of warehouse storage device information that was received from the warehouse storage device.

At 306, warehouse information corresponding to the warehouse identifier based at least in part on the warehouse storage device information is stored. In various embodiments, establishing a warehouse identifier comprises establishing a record and an identifier corresponding to the warehouse storage device. Because, in some embodiments, there is a one-to-one correspondence between a warehouse storage device and a warehouse, the warehouse identifier can uniquely identify the warehouse and the corresponding warehouse storage device. Furthermore, the warehouse information corresponding to a warehouse identifier comprises the warehouse storage device information received from the warehouse storage device that is associated with that warehouse identifier. As such, in various embodiments, the warehouse information may comprise: a warehouse identifier, the scope of coverage from the warehouse storage device information, the one or more transfer cycles from the warehouse storage device information, and the total quantity of resources transferrable corresponding to each transfer cycle from the warehouse storage device information.

At 308, request information transmitted from a client is received. The client may comprise a client device that is used by a resource user to transmit request information to the warehouse management server via a network. In various embodiments, the request information may comprise: a request information identifier, the resource transfer destination, the target warehouse identifier, a specified transfer cycle associated with the target warehouse identifier, the name of the resources that need to be transferred during the specified transfer cycle, and the quantity of resources that is requested to be transferred.

At 310, it is determined whether the request information satisfies a first preset rule or a second preset rule.

In various embodiments, the first preset rule indicates that 1) the resource transfer destination of the request information matches the scope of coverage of the warehouse associated with the target warehouse identifier of the request information and 2) the quantity of the requested resources in the request information is less than or equal to the total quantity of the requested resources that is transferrable corresponding to the specified transfer cycle in the warehouse associated with the target warehouse identifier of the request information.

In various embodiments, the second preset rule indicates that 1) the resource transfer destination of request information matches the scope of coverage of the target warehouse identifier of the request information and 2) the quantity of the requested resources in the request information is less than or equal to the sum of the total quantities of the requested resources that is transferrable over multiple (i.e., more than one) transfer cycles in the warehouse associated with the target warehouse identifier. In some embodiments, the specified transfer cycle that is included in the request information is included in the multiple transfer cycles in the warehouse associated with the target warehouse identifier.

At 312, lock-in information corresponding to whichever one of the first preset rule and the second preset rule that is satisfied by the request information is generated.

If the request information received by the warehouse management server satisfies the first preset rule, then the warehouse management server generates lock-in information corresponding to the first preset rule indicating that the request can be fulfilled based on the first preset rule. In various embodiments, the lock-in information corresponding to the first preset rule may comprise: a lock-in information identifier, resource user information, the resource transfer destination that was included in the request information, the target warehouse identifier that was included in the request information, the specified transfer cycle associated with the target warehouse identifier that was included in the request information, the name of the resources that need to be transferred within the specified transfer cycle that is included in the request information, and the quantity of resources that is requested to be transferred that is included in the request information.

If the request information received by the warehouse management server satisfies the second preset rule, then the warehouse management server generates lock-in information corresponding to the second preset rule indicating that the request can be fulfilled based on the second preset rule. In various embodiments, the lock-in information corresponding to the second preset rule may comprise: a lock-in information identifier, resource user information, the resource transfer destination that was included in the request information, the target warehouse identifier that was included in the request information, the multiple transfer cycles associated with the target warehouse identifier whose sum of total quantities of transferrable resources is greater than the quantity of resources that is requested to be transferred that is included in the request information, the name of the resources that need to be transferred within the multiple transfer cycles that is included in the request information, and the quantity of resources that is requested to be transferred that is included in the request information.

At 314, the warehouse information is updated based at least in part on the lock-in information. The warehouse management server updates its stored warehouse information based on the lock-in information. In various embodiments, in the event that the request information satisfied the first preset rule, updating the warehouse information of the warehouse includes updating the quantity of resources transferrable during the specified transfer cycle included in the warehouse information to be a new quantity that is the quantity of the requested resources before the update less the requested quantity that is included in the request information. In various embodiments, in the event that the request information satisfied the second preset rule, updating the warehouse information of the warehouse includes updating the quantity of resources transferrable during each of the multiple transfer cycles included in the warehouse information to be a new quantity that is the quantity of the requested resources before the update less a portion of the requested quantity that is included in the request information.

At 316, the lock-in information is transmitted to the client and to the warehouse storage device. Lock-in information corresponding to either the first preset rule or the second preset rule is transmitted to both the client and the warehouse storage device.

In various embodiments, the lock-in information is used by the warehouse storage device to update the quantity of the resources that are stored at the warehouse. For example, based on the lock-in information that the warehouse storage device receives, the storage device can update its own stored quantities of resources transferrable during the transfer cycles associated with the lock-in information.

In various embodiments, the lock-in information can be used as verification information at the time that the resources that are associated with the request information are used.

At 318, a confirmation message is received from the client confirming use of requested resources. In various embodiments, the confirmation message comprises the lock-in information identifier and the confirmation time.

At 320, resource transfer information is generated based at least in part on the confirmation message.

The resource transfer information is generated based on the confirmation message and whichever of the first preset rule or second preset rule that was satisfied. In some embodiments, in the event that the request information satisfies the first preset rule, the resource transfer information comprises one or more of the following: a resource transfer information identifier, the name of the requested resource, the specified transfer cycle, the quantity of the requested resource, the address of the resource user, resource user information, and the confirmation time. In some embodiments, in the event that the request information satisfies the second preset rule, the resource transfer information comprises one or more of the following: a resource transfer information identifier, the name of the requested resource, the multiple transfer cycles whose sum of total quantities of transferrable resources is greater than the quantity of resources that is requested to be transferred, the quantity of the requested resource, the address of the resource user, resource user information, and the confirmation time.

At 322, the resource transfer information is transmitted to the warehouse storage device. The resource transfer information is transmitted to the warehouse storage device in order to facilitate the warehouse storage device in causing the resource transfer operation to be performed.

In some embodiments, the warehouse management server can also receive correction information transmitted from the warehouse storage device and the warehouse management server can update its own stored version of the warehouse information corresponding to that warehouse storage device based on the correction information. In some embodiments, the correction information can be used to correct one or more of the following pieces of information that is included in the warehouse storage device information: the warehouse storage device address information, the scope of coverage information corresponding to the warehouse storage device, a minimum of one transfer cycle associated with the storage device, and the total quantity of resources transferrable corresponding to each transfer cycle. After it has received and stored the warehouse information, the warehouse management server can receive correction information transmitted from the warehouse storage device at any time in order to ensure the consistency of the warehouse information stored at the warehouse management server and that which is stored at the warehouse storage device.

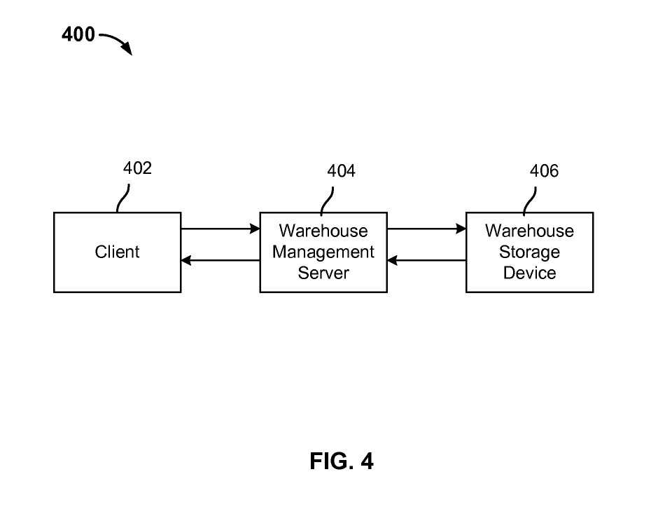

FIG. 4 is a diagram showing an embodiment of a system for managing warehouse information. In the example, system 400 includes client 402, warehouse management server 404, and warehouse storage device 406.

Client 402 is configured to transmit request information to warehouse management server 404 to lock in a requested quantity of a named resource. Client 402 is further configured to lock in information returned from warehouse management server 404 in the event that the request information satisfies one of the first preset rule and the second preset rule. Client 402 is configured to transmit a confirmation message to warehouse management server 404 to confirm the use of the requested resources.

Warehouse management server 404 is configured to receive warehouse storage device information transmitted from warehouse storage device 406, establish a warehouse identifier corresponding to warehouse storage device 406, and store warehouse information corresponding to the warehouse identifier based at least in part on the warehouse storage device information. Warehouse management server 404 is configured to receive request information transmitted from client 402 and determine whether the request information satisfies one of a first preset rule or a second preset rule. If one of the first preset rule or the second preset rule is satisfied, then warehouse management server 404 is configured to generate lock-in information and return the lock-in information to client 402 and warehouse storage device 406. Warehouse management server 404 is configured to receive confirmation messages transmitted from client 402 that confirm the use of the requested resources, generate resource transfer information based on the confirmation message, and transmit the resource transfer information to warehouse storage device 406.

Warehouse storage device 406 is configured to store warehouse storage device information corresponding to the resources provided by one or more resource providers, transmit the warehouse storage device information to warehouse management server 404, receive resource transfer information transmitted from warehouse management server 404, and perform resource distribution based on the resource transfer information.

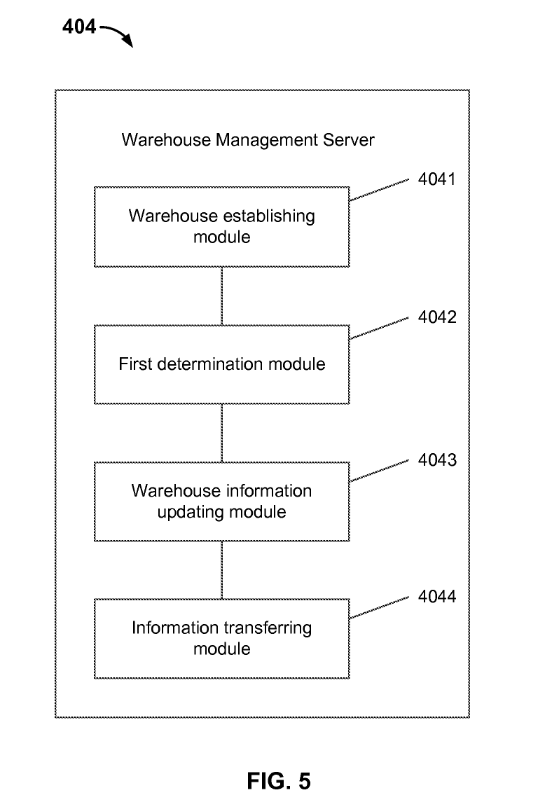

FIG. 5 is a diagram of a first example of a warehouse management server. In some embodiments, warehouse management server 404 of system 400 of FIG. 4 can be implemented using the example warehouse management server of FIG. 5. In this example, the warehouse management server includes warehouse establishing module 4041, first determination module 4042, warehouse information updating module 4043, and information transferring module 4044.

The modules can be implemented as software components executing on one or more processors, as hardware such as programmable logic devices, and/or Application Specific Integrated Circuits design elements can be embodied by a form of software products which can be stored in a nonvolatile storage medium (such as optical disk, flash storage device, mobile hard disk, etc.), including a number of instructions for making a computer device (such as personal computers, servers, network equipment, etc.) Implement the methods described in the embodiments of the present invention. The modules may be implemented on a single device or distributed across multiple devices

Warehouse establishing module 4041 is configured to receive warehouse storage device information transmitted from a warehouse storage device, establish a warehouse identifier corresponding to the warehouse storage device, and store warehouse information corresponding to the warehouse identifier based at least in part on the warehouse storage device information.

First determination module 4042 is configured to receive request information transmitted from the client and determine whether the request information satisfies a first preset rule. If the first preset rule is satisfied, then first determination module 4042 is configured to generate lock-in information corresponding to the satisfied first preset rule.

Warehouse information updating module 4043 is configured to update the stored warehouse information based on the lock-in information generated by first determination module 4042. Warehouse information updating module 4043 is also configured to transmit the lock-in information to the client and the warehouse storage device.

Information transferring module 4044 is configured to receive confirmation messages transmitted from the client confirming the use of the requested resources, generate resource transfer information based on the confirmation message, and transfer the resource transfer information to the warehouse storage device.

In some embodiments, the warehouse management server may also comprise an information correction module (not shown in the diagram). The information correction module can be configured to receive correction information transmitted from the warehouse storage device and to update the stored warehouse information based on the correction information.

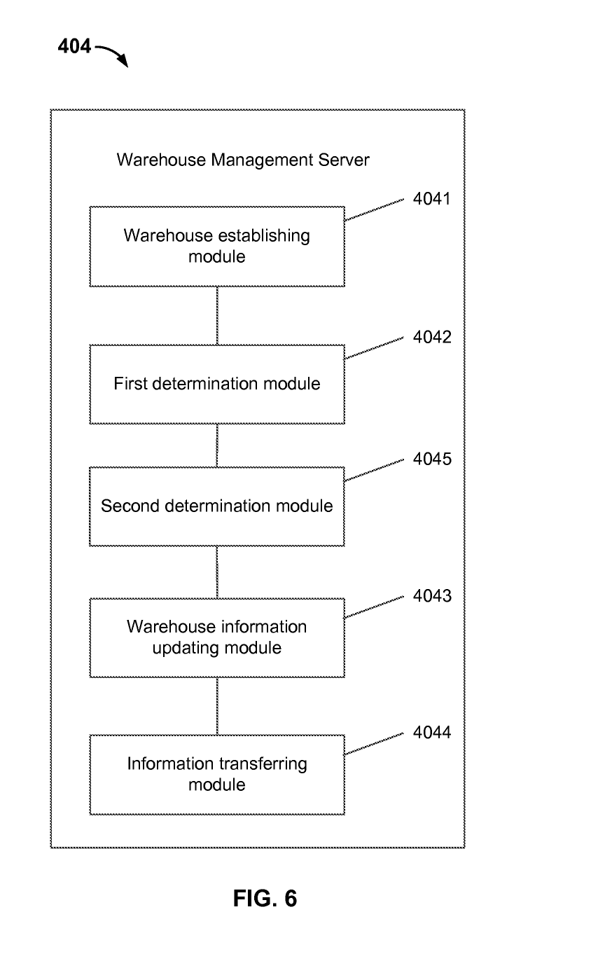

FIG. 6 is a diagram of a second example of a warehouse management server. In some embodiments, warehouse management server 404 of system 400 of FIG. 4 can be implemented using the example warehouse management server of FIG. 6. In this example, the warehouse management server includes warehouse establishing module 4041, first determination module 4042, second determination module 4045, warehouse information updating module 4043, and information transferring module 4044. The difference between the example warehouse management server of FIG. 6 and that of FIG. 5 is that the example warehouse management server of FIG. 6 includes an additional second determination module 4045.

Second determination module 4045 is configured to receive request information transmitted from the client and determine whether the request information satisfies a second preset rule (in the event that the request information did not satisfy the first preset rule). If the second preset rule is satisfied, then second determination module 4045 is configured to generate lock-in information corresponding to the satisfied second preset rule.

Similarly, warehouse information updating module 4043 is further configured to update the stored warehouse information based on the lock-in information generated by second determination module 4045. Warehouse information updating module 4043 is also configured to transmit the lock-in information to the client and the warehouse storage device.

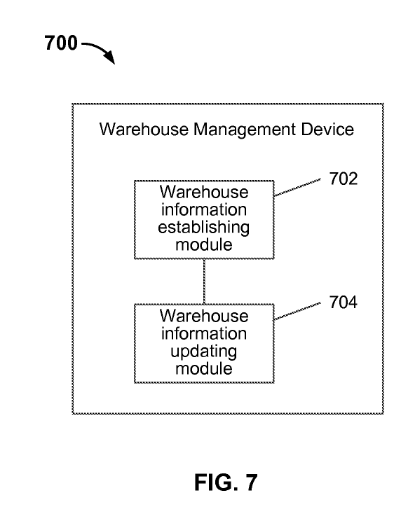

FIG. 7 is a diagram of an embodiment of a warehouse management device. In the example, warehouse management device 700 includes warehouse information establishing module 702 and warehouse information updating module 704.

Warehouse information establishing module 702 is configured to receive the information transmitted from one or more warehouse storage devices. Warehouse information establishing module 702 is configured to establish warehouse identifiers corresponding to the warehouse storage devices and store warehouse information based at least in part on the received warehouse storage device information.

Warehouse information updating module 704 is configured to update the stored warehouse information based on the lock-in information generated by the warehouse management device.

In some embodiments, the warehouse management device may further comprise an information correction module. The information correction module is configured to receive correction information transmitted from the warehouse storage device and to update the warehouse information based on the correction information.

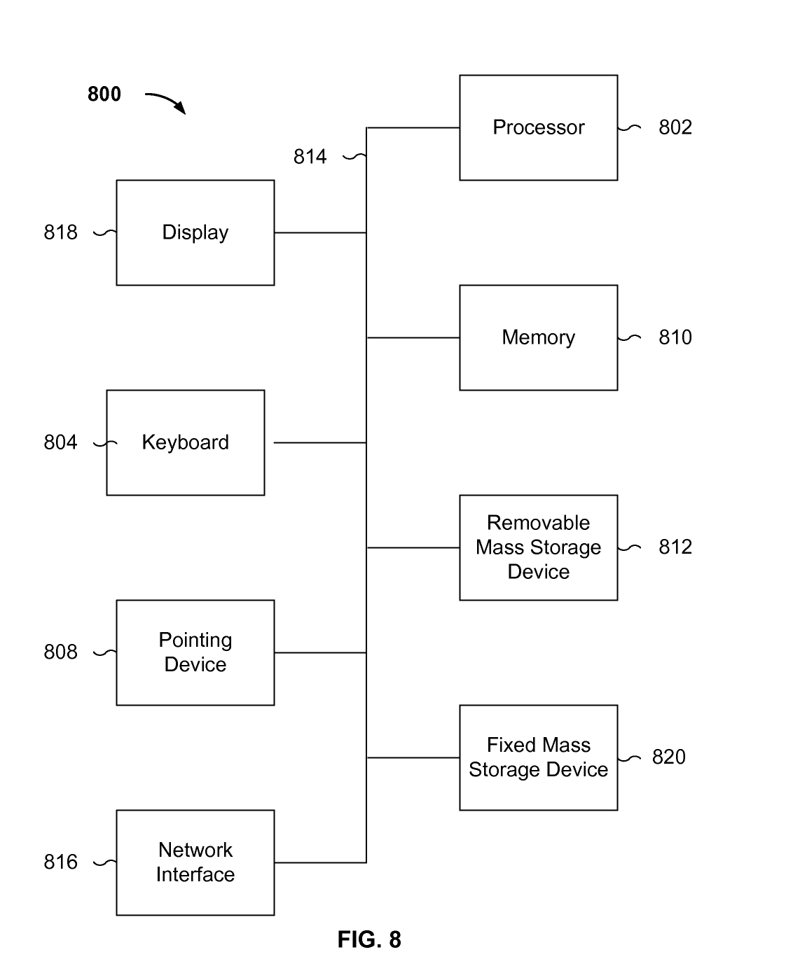

FIG. 8 is a functional diagram illustrating an embodiment of a programmed computer system for managing warehouse information. As will be apparent, other computer system architectures and configurations can be used to manage warehouse information. Computer system 800, which includes various subsystems as described below, includes at least one microprocessor subsystem (also referred to as a processor or a central processing unit (CPU)) 802. For example, processor 802 can be implemented by a single-chip processor or by multiple processors. In some embodiments, processor 802 is a general purpose digital processor that controls the operation of the computer system 800. Using instructions retrieved from memory 810, the processor 802 controls the reception and manipulation of input data, and the output and display of data on output devices (e.g., display 818).

Processor 802 is coupled bi-directionally with memory 810, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 802. Also as is well known in the art, primary storage typically includes basic operating instructions, program code, data, and objects used by the processor 802 to perform its functions (e.g., programmed instructions). For example, memory 810 can include any suitable computer readable storage media, described below, depending on whether, for example, data access needs to be bi-directional or uni-directional. For example, processor 802 can also directly and very rapidly retrieve and store frequently needed data in a cache memory (not shown).

A removable mass storage device 812 provides additional data storage capacity for the computer system 800 and is coupled either bi-directionally (read/write) or uni-directionally (read only) to processor 802. For example, storage 812 can also include computer readable media such as magnetic tape, flash memory, PC-CARDS, portable mass storage devices, holographic storage devices, and other storage devices. A fixed mass storage 820 can also, for example, provide additional data storage capacity. The most common example of fixed mass storage 820 is a hard disk drive. Mass storages 812, 820 generally store additional programming instructions, data, and the like that typically are not in active use by the processor 802. It will be appreciated that the information retained within mass storages 812 and 820 can be incorporated, if needed, in standard fashion as part of memory 810 (e.g., RAM) as virtual memory.

In addition to providing processor 802 access to storage subsystems, bus 814 can also be used to provide access to other subsystems and devices. As shown, these can include a display 818, a network interface 816, a keyboard 804, and a pointing device 808, as well as an auxiliary input/output device interface, a sound card, speakers, and other subsystems as needed. For example, the pointing device 808 can be a mouse, stylus, track ball, or tablet, and is useful for interacting with a graphical user interface.

The network interface 816 allows processor 802 to be coupled to another computer, computer network, or telecommunications network using a network connection as shown. For example, through the network interface 816, the processor 802 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect the computer system 800 to an external network and transfer data according to standard protocols. For example, various process embodiments disclosed herein can be executed on processor 802, or can be performed across a network such as the Internet, intranet networks, or local area networks, in conjunction with a remote processor that shares a portion of the processing. Additional mass storage devices (not shown) can also be connected to processor 802 through network interface 816.

An auxiliary I/O device interface (not shown) can be used in conjunction with computer system 800. The auxiliary I/O device interface can include general and customized interfaces that allow the processor 802 to send and, more typically, receive data from other devices such as microphones, touch-sensitive displays, transducer card readers, tape readers, voice or handwriting recognizers, biometrics readers, cameras, portable mass storage devices, and other computers.

For convenience of description, when describing the device, servers, and systems above, functions are described as separate modules. Of course, during implementation of the present application, the functions of the various modules may be achieved in the same or multiple software and/or hardware configurations.

As can be seen through the description of the embodiment above, persons skilled in the art can clearly understand that the present application can be realized with the aid of software plus the necessary common hardware platform. Understood this way, the technical scheme of the present application may be substantively (or that is, with regard to that part which contributes to the prior art) embodied in the form of a software product. In one typical configuration, the computing equipment comprises one or more processors (CPUs), input/output interfaces, network interfaces, and a storage device. This computer software product may include some commands used to cause a piece of computer equipment (which can be a personal computer, a server, or network equipment) to execute the methods described by the various embodiments of the present application or by certain portions of the embodiments. The computer software product may be stored in storage device. A storage device may include such forms as volatile storage devices in computer-readable media, random access storage devices (RAM) and/or non-volatile storage devices, such as a read-only storage device (ROM) or flash storage device (flash RAM). A storage device is an example of a computer-readable medium. Computer-readable media, including permanent and non-permanent and removable and non-removable media, may achieve information storage by any method or technology. Information can be computer-readable commands, data structures, program modules, or other data. Examples of computer storage media include but are not limited to a phase-change storage device (PRAM), a static random access storage device (SRAM), a dynamic random access storage device (DRAM), other types of random access storage device (RAM), a read-only storage device (ROM), an electrically erasable programmable read-only storage device (EEPROM), a flash storage device or other storage device technology, a compact disk read-only storage device (CD-ROM), a digit multifunction disc (DVD) or other optical storage, magnetic cassettes, magnetic tape or magnetic disc storage, or other magnetic storage equipment or any other non-transmission media that can be used to store information that is accessible to computers. As defined in this document, computer-readable media does not include temporary computer-readable media, (transitory media), such as modulated data signals and carrier waves.

The present application may be used in many general or specialized computer systems or configurations. For example: personal computers, servers, handheld devices or portable equipment, tablet type equipment, multiprocessor systems, microprocessor-based systems, set-top boxes, programmable consumer electronic equipment, networked PCs, minicomputers, mainframe computers, distributed computing environments that include any of the systems or equipment above, and so forth.

The present application can be described in the general context of computer executable commands executed by a computer, such as a program module. Generally, program modules include routines, programs, objects, components, data structures, etc. to execute specific tasks or achieve specific abstract data types. The present application can also be carried out in distributed computing environments; in such distributed computing environments, tasks are executed by remote processing equipment connected via communication networks.

Although the present application has been portrayed through embodiments, persons with ordinary skill in the art know that the present application has many variants and variations that do not depart from the spirit of the present application. It is hoped that the attached claims include these variants and variations without departing from the spirit of the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
receive warehouse storage device information from a warehouse storage device;
establish a warehouse identifier corresponding to the warehouse storage device;
store warehouse information corresponding to the warehouse identifier based at least in part on the warehouse storage device information;
receive request information from a client;
determine whether the request information satisfies a first preset rule or a second preset rule;
generate lock-in information corresponding to whichever of the first preset rule and the second preset rule is satisfied by the request information;
update the warehouse information based at least in part on the lock-in information;
transmit the lock-in information to the client and to the warehouse storage device;
receive a confirmation message from the client confirming use of requested resources;
generate resource transfer information based at least in part on the confirmation message; and
transmit the resource transfer information to the warehouse storage device; and
one or more memories coupled to the one or more processors and configured to provide instructions to the one or more processors.

2. The system of claim 1, wherein the warehouse information comprises one or more of the following: one or more transfer cycles and quantities of transferrable resources corresponding to respective ones of the one or more transfer cycles, scope of coverage, the warehouse identifier, or a warehouse storage device address.

3. The system of claim 1, wherein the request information comprises one or more of the following: a request information identifier, a resource transfer destination, a target warehouse identifier, a specified transfer cycle, a name of resources that need to be transferred during the specified transfer cycle, or a quantity of resources that is requested to be transferred.

4. The system of claim 1, wherein the first preset rule comprises 1) a resource transfer destination of the request information matches a scope of coverage of a warehouse associated with a target warehouse identifier of the request information and 2) a quantity of requested resources in the request information is less than or equal to a total quantity of the requested resources that is transferrable corresponding to a specified transfer cycle in a warehouse associated with the target warehouse identifier of the request information.

5. The system of claim 1, wherein the second preset rule comprises 1) a resource transfer destination of the request information matches the scope of coverage of a warehouse associated with a target warehouse identifier of the request information and 2) a quantity of requested resources in the request information is less than or equal to a sum of the total quantities of the requested resources that is transferrable over more than one transfer cycle in the warehouse associated with the target warehouse identifier of the request information.

6. The system of claim 1, wherein to update the warehouse information based at least in part on the lock-in information comprises to update a quantity of resources transferrable during a specified transfer cycle included in the warehouse information to be a new quantity based at least in part on a requested quantity that is included in the request information.

7. The system of claim 1, wherein the resource transfer information is sorted among one or more sets of resource transfer information and corresponding resource transfers are performed based at least in part on the sorting.

8. The system of claim 1, wherein the one or more processors are further configured to:
receive correction information from the warehouse storage device; and
update the warehouse information based at least in part on the correction information.

9. A method, comprising:
receiving warehouse storage device information from a warehouse storage device;
establishing a warehouse identifier corresponding to the warehouse storage device;
storing warehouse information corresponding to the warehouse identifier based at least in part on the warehouse storage device information;
receiving request information from a client;
determining, using one or more processors, whether the request information satisfies a first preset rule or a second preset rule;
generating lock-in information corresponding to whichever of the first preset rule and the second preset rule is satisfied by the request information;
updating the warehouse information based at least in part on the lock-in information;
transmitting the lock-in information to the client and to the warehouse storage device;
receiving a confirmation message from the client confirming use of requested resources;
generating resource transfer information based at least in part on the confirmation message; and
transmitting the resource transfer information to the warehouse storage device.

10. The method of claim 9, wherein the warehouse information comprises one or more of the following: one or more transfer cycles and quantities of transferrable resources corresponding to respective ones of the one or more transfer cycles, scope of coverage, the warehouse identifier, or a warehouse storage device address.

11. The method of claim 9, wherein the request information comprises one or more of the following: a request information identifier, a resource transfer destination, a target warehouse identifier, a specified transfer cycle, a name of resources that need to be transferred during the specified transfer cycle, or a quantity of resources that is requested to be transferred.

12. The method of claim 9, wherein the first preset rule comprises 1) a resource transfer destination of the request information matches a scope of coverage of a warehouse associated with a target warehouse identifier of the request information and 2) a quantity of requested resources in the request information is less than or equal to a total quantity of the requested resources that is transferrable corresponding to a specified transfer cycle in a warehouse associated with the target warehouse identifier of the request information.

13. The method of claim 9, wherein the second preset rule comprises 1) a resource transfer destination of the request information matches the scope of coverage of a warehouse associated with a target warehouse identifier of the request information and 2) a quantity of requested resources in the request information is less than or equal to a sum of the total quantities of the requested resources that is transferrable over more than one transfer cycle in the warehouse associated with the target warehouse identifier of the request information.

14. The method of claim 9, wherein updating the warehouse information based at least in part on the lock-in information comprises updating a quantity of resources transferrable during a specified transfer cycle included in the warehouse information to be a new quantity based at least in part on a requested quantity that is included in the request information.

15. The method of claim 9, wherein the resource transfer information is sorted among one or more sets of resource transfer information and corresponding resource transfers are performed based at least in part on the sorting.

16. The method of claim 9, wherein the one or more processors are further configured to:
receive correction information from the warehouse storage device; and
update the warehouse information based at least in part on the correction information.

17. A computer program product, the computer program product being embodied in a non-transitory computer readable storage medium and comprising computer instructions for:
receiving warehouse storage device information from a warehouse storage device;
establishing a warehouse identifier corresponding to the warehouse storage device;
storing warehouse information corresponding to the warehouse identifier based at least in part on the warehouse storage device information;
receiving request information from a client;
determining whether the request information satisfies a first preset rule or a second preset rule;
generating lock-in information corresponding to whichever of the first preset rule and the second preset rule is satisfied by the request information;
updating the warehouse information based at least in part on the lock-in information;
transmitting the lock-in information to the client and to the warehouse storage device;
receiving a confirmation message from the client confirming use of requested resources;
generating resource transfer information based at least in part on the confirmation message; and
transmitting the resource transfer information to the warehouse storage device.
